(19) United States
(12) Patent Application Publication
(10) Pub. No.: US 2026/0040103 A1
(43) Pub. Date: Feb. 5, 2026

(54) METHOD, DEVICE AND COMPUTER STORAGE MEDIUM OF COMMUNICATION

(71) Applicant: NEC Corporation, Tokyo (JP)

(72) Inventors: Gang WANG, Beijing (CN); Peng GUAN, Beijing (CN); Wei CHEN, Beijing (CN)

(73) Assignee: NEC Corporation, Tokyo (JP)

(21) Appl. No.: 19/100,682

(22) PCT Filed: Aug. 4, 2022
(86) PCT No.: PCT/CN2022/110324

§ 371 Date: Feb. 3, 2025

(51) Int. Cl. H04W 24/08; H04W 24/02

(52) U.S. Cl. CPC H04W 24/08; H04W 24/02

(57) ABSTRACT

Embodiments of the present disclosure relate to methods, devices and computer readable media of communication. In one aspect, in accordance with a determination that an event occurs, a terminal device deactivates or reduces capabilities of an AI model. The event comprising at least one of the following: a signal measurement criterion is met; an overheating condition is detected; a RLF is detected; a first indication indicating the deactivating or reducing is received; the terminal device enters an idle or inactive state; or a handover to a target cell is to be performed, an AI model associated with the target cell being specific to a cell. In this way, management of AI model may be achieved and power saving may be attained.

### TECHNICAL FIELD

Embodiments of the present disclosure generally relate to the field of telecommunication, and in particular, to methods, devices and computer storage media of communication for management of an artificial intelligence (AI) model.

### BACKGROUND

The fifth generation (5G) networks are expected to meet challenges of consistent optimization of increasing numbers of key performance indicators (KPIs) including latency, reliability, connection density, user experience, energy efficiency, etc. AI/machine learning (ML) provides a powerful tool to help operators to improve network management and user experience by analyzing data collected and autonomously processed that may yield further insights. However, some issues may exist, such as some AI models are useless but required to consume more power consumption, or some AI models might not derive reasonable or precise output, or AI generalization performance is not good. All of these may degrade the user experience.

### SUMMARY

In general, embodiments of the present disclosure provide methods, devices and computer storage media of communication for management of an AI model.

In a first aspect, there is provided a method of communication. The method comprises: determining, at a terminal device, that an event occurs; and deactivating or reducing capabilities of an artificial intelligence model, the event comprising at least one of the following: a signal measurement criterion is met; an overheating condition is detected; a radio link failure is detected; a first indication indicating the deactivating or reducing is received; the terminal device enters an idle or inactive state; or a handover to a target cell is to be performed, an artificial intelligence model associated with the target cell being specific to a cell.

In a second aspect, there is provided a method of communication. The method comprises: transmitting, at a terminal device and to a network device, a measurement report comprising information associated with an artificial intelligence model.

In a third aspect, there is provided a method of communication. The method comprises: transmitting, at a network device and to a terminal device, at least one of the following: a configuration of a signal measurement criterion for an artificial intelligence model; a configuration for detection of an overheating condition; a configuration for detection of a radio link failure; a first indication indicating deactivation or reduction of the capabilities of the artificial intelligence model; a radio resource control release message; or a radio resource control reconfiguration message indicating a handover to a target cell, an artificial intelligence model associated with the target cell being specific to a cell.

In a fourth aspect, there is provided a method of communication. The method comprises: receiving, at a network device and from a terminal device, a measurement report comprising information associated with an artificial intelligence model.

In a fifth aspect, there is provided a device of communication. The device comprises a processor configured to cause the device to perform the method according to any of the first to fourth aspects of the present disclosure.

In a sixth aspect, there is provided a computer readable medium having instructions stored thereon. The instructions, when executed on at least one processor, cause the at least one processor to perform the method according to any of the first to fourth aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates a schematic diagram illustrating a process of communication according to embodiments of the present disclosure;

FIG. 3 illustrates a schematic diagram illustrating another process of communication according to embodiments of the present disclosure;

FIG. 4 illustrates an example method of communication implemented at a terminal device in accordance with some embodiments of the present disclosure;

FIG. 5 illustrates another example method of communication implemented at a terminal device in accordance with some embodiments of the present disclosure;

FIG. 6 illustrates an example method of communication implemented at a network device in accordance with some embodiments of the present disclosure;

FIG. 7 illustrates another example method of communication implemented at a network device in accordance with some embodiments of the present disclosure; and

FIG. 8 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure.

The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “a connected state” may be interchangeably used with “a RRC_CONNECTED state”, the term “an idle state” may be interchangeably used with “a RRC_IDLE state”, and the term “an inactive state” may be interchangeably used with “a RRC_INACTIVE state”.

Currently, it is intended to specify data collection enhancements and signaling support within existing NG-RAN interfaces and architecture (including non-split architecture and split architecture) for AI/ML-based Network Energy Saving, Load Balancing and Mobility Optimization. However, some AI models are useless but required to consume more power consumption, or some AI models might not derive reasonable or precise output, or AI generalization performance is not good. All of these may degrade the user experience.

In view of this, embodiments of the present disclosure provide solutions of communication so as to overcome the above and other potential issues. In one aspect, in accordance with a determination that an event occurs, a terminal device deactivates or reduces capabilities of an AI model. In this way, mobility management may be improved and power saving may be achieved. In another aspect, a terminal device transmits a measurement report comprising information associated with an AI model. In this way, information of an AI model may be reported to a network for a better decision of mobility management.

Principles and implementations of the present disclosure will be described in detail below with reference to the figures.

### Example of Communication Network

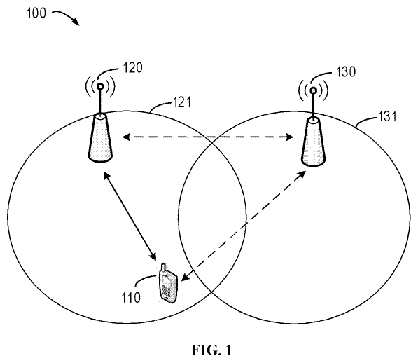

FIG. 1 illustrates a schematic diagram of an example communication network 100 in which some embodiments of the present disclosure can be implemented. As shown in FIG. 1, the communication network 100 may include terminal device 110 and network device 120 and 130. The network device 120 may provide at least one cell (for convenience, only a cell 121 is shown) to serve one or more terminal devices, and the network device 130 may also provide at least one cell (for convenience, only a cell 131 is shown) to serve one or more terminal devices. In this example, the terminal device 110 is shown as being located in the cell 121 and served by the network device 120.

It is to be understood that the number of devices or cells in FIG. 1 is given for the purpose of illustration without suggesting any limitations to the present disclosure. The communication network 100 may include any suitable number of network devices and/or terminal devices and/cells adapted for implementing implementations of the present disclosure.

As shown in FIG. 1, the terminal device 110 may communicate with any of the network devices 120 and 130 via Uu interface. The network devices 120 and 130 may communicate with each other via Xn interface. The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In some embodiments where the terminal device 110 is served by the network device 120, a measurement procedure may be performed. During the measurement procedure, the network device 120 may configure a measurement ID (measID) to the terminal device 110, the measID being associated with a report configuration (reportConfig) and a measurement object. The terminal device 110 may perform a signal measurement based on the measID and the associated measurement object and reportConfig. If an event criterion (e.g., a signal measurement criterion) is met, the terminal device 110 may add the measID into a UE variable VarMeasReportList. Once the terminal device 110 has the UE variable, the terminal device 110 may initiate a measurement report. The terminal device 110 may add measurement results within the measurement report and send the measurement report to the network device 120.

In some embodiments, the terminal device 110 may be handed over from the cell 121 to the cell 131. In some embodiments, the network device 120 and the network device 130 may be the same device. In some embodiments, the network device 120 and the network device 130 may be different devices.

In some embodiments, the terminal device 110 may support an AI model, e.g., for mobility management. In some embodiments, an input of an AI model may comprise at least one of the following: location information of the terminal device 110, radio link information of the terminal device 110, subscription and traffic information of the terminal device 110, history information of the terminal device 110, related information of other terminal devices, geography and road network information, current status information of public transport vehicles, or current transport conditions. In some embodiments, an output of an AI model may comprise at least one of the following: location estimation for the terminal device 110, trajectory prediction for the terminal device 110, traffic prediction for the terminal device 110, reference signal receiving power (RSRP) prediction for the terminal device 110 or handover information prediction for the terminal device 110. In some embodiments, based on an output of an AI model, the network device 120 or 130 may optimize mobility management comprising at least one of the following: a measurement configuration, a conditional handover configuration and resource reservation, a handover decision, a radio access network-based notification area (RNA) configuration, or a cell load prediction. It is to be understood that any other suitable information may also serve as an input or output of an AI model, and any other suitable mobility management functions are also feasible.

However, in some scenarios, the terminal device 110 may be located in a center of the cell 121 and may have no handover requirement. In this case, an AI model for mobility management (e.g., RSRP prediction or the like) may be unnecessary to continuously operate. In some scenarios, an AI model might not derive reasonable or precise output, for example, predicted trajectory may be incorrect. In this case, the AI model for mobility management (e.g., trajectory prediction or the like) may be unnecessary to continuously operate.

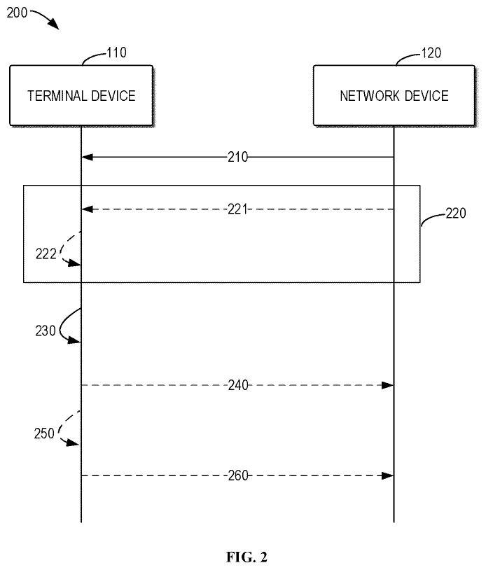

In view of this, embodiments of the present disclosure provide solutions for management of an AI model. In one solution, in accordance with a determination that an event occurs, a terminal device deactivates or reduces capabilities of an AI model. The event comprises at least one of the following: a signal measurement criterion is met; an overheating condition is detected; a radio link failure (RLF) is detected; an indication (for convenience, also referred to as a first indication herein) indicating the deactivating or reducing is received; the terminal device enters an idle or inactive state; or a handover to a target cell is to be performed, an AI model associated with the target cell being specific to a cell. For illustration, the solution will be detailed with reference to FIG. 2 below.

### Example Implementation of Disabling or Enabling AI Model

FIG. 2 illustrates a schematic diagram illustrating a process 200 of communication according to embodiments of the present disclosure. For the purpose of discussion, the process 200 will be described with reference to FIG. 1. The process 200 may involve the terminal device 110 and the network device 120 as illustrated in FIG. 1. It is to be understood that the steps and the order of the steps in FIG. 2 are merely for illustration, and not for limitation. For example, the order of the steps may be changed. Some of the steps may be omitted or any other suitable additional steps may be added. It is assumed that the terminal device 110 is located in the cell 121 and served by the network device 120. The terminal device 110 supports an AI model.

With reference to FIG. 2, the network device 120 may transmit 210, to the terminal device 110, a configuration associated with the event for evaluating AI model activation or deactivation.

The terminal device 110 may determine 220 whether the event occurs. In some embodiments, the network device 120 may also transmit 221, to the terminal device 110, an indication indicating whether the terminal device 110 needs to evaluate the AI model based on the event. If the indication indicates that the terminal device 110 needs to evaluate the AI model, the terminal device 110 may determine 222 whether the event occurs. For example, the network device 120 may transmit an indication (for convenience, also referred to as a second indication herein) indicating whether the terminal device 110 needs to evaluate the AI model based on the signal measurement criterion. If the indication indicates that the terminal device 110 needs to evaluate the AI model, the terminal device 110 may perform signal measurements based on the signal measurement criterion. It is to be understood that the indication is optional.

If the event occurs, the terminal device 110 may deactivate or reduce 230 capabilities of the AI model. In some embodiments, the terminal device 110 may deactivate all the capabilities of the AI model. In some embodiments, the terminal device 110 may deactivate a part of the capabilities of the AI model. For example, the terminal device 110 may deactivate any one or more of AI model inference, AI model training, AI model monitor, AI model updating, and data collection functionalities. It is to be understood that any other suitable ways are also feasible.

In some embodiments, the terminal device 110 may reduce the capabilities of the AI model. For example, the terminal device 110 may switch to another AI model (for example, a simple model). In another example, the terminal device 110 may reduce AI output accuracy requirement. In still another example, the terminal device 110 may reduce computing latency requirement. In yet another example, the terminal device 110 may reduce a period of an AI model monitor. It is to be understood that any other suitable ways are also feasible.

Continue to refer to FIG. 2, the terminal device 110 may transmit 240 information (for convenience, also referred to as first information herein) indicating that the capabilities of the AI model is deactivated or reduced. In some embodiments, the terminal device 110 may carry the first information in an information element (IE) of a UE assistance information (UAI) message or any other suitable messages. It is to be understood that the IE may be any IE existing or to be developed in future.

In some embodiments where all the capabilities of the AI model are deactivated, the first information may comprise or indicate deactivation of the capabilities of the AI model. In some embodiments where a part of the capabilities of the AI model is deactivated, the first information may comprise or indicate a list of the deactivated capabilities of the AI model. In some embodiments where the capabilities of the AI model are reduced, the first information may comprise or indicate a list of the reduced capabilities of the AI model. In some embodiments, the first information may comprise a cause indicating the event so as to indicate which cause initiates the transmission (e.g., the UAI transmission). It is to be understood that the first information may comprise any combination of the above information and any other suitable information.

In some embodiments, the terminal device 110 may start 250 a prohibit timer upon transmission of the first information. In this way, frequent transmission of a UAI message may be restricted or avoided.

Continue to refer to FIG. 2, the terminal device 110 may transmit 260, to the network device 120, information (for convenience, also referred to as second information herein) indicating that the AI model is to be resumed. In some embodiments, the terminal device 110 may transmit the second information via a UAI message or any other suitable messages.

In some embodiments, the terminal device 110 may transmit the second information by causing absence of the first information in the IE used for carrying the first information. In some embodiments, the IE does not comprise any of the following: deactivation of the capabilities of the AI model; a list of the deactivated capabilities of the AI model; a list of the reduced capabilities of the AI model; and a cause indicating the event. In this way, the AI model may be indicated to be resumed or enabled.

For illustration, some example embodiments will be described below.

### 1. Signal Measurement Based Method

In some embodiments, the event is that a signal measurement criterion is met. In some embodiments, if a signal channel is good enough or stable, the terminal device 110 may deactivate or reduce capabilities of the AI model. In this way, there is no need for mobility evaluation in a good or stable channel state, so that a terminal device can deactivate or reduce AI function to achieve power saving. For illustration, some example embodiments will be described in connection with Embodiments 1 to 3.

### Embodiment 1

In this embodiment, the signal measurement criterion is a measurement criterion for a stationary terminal device (i.e., a radio resource management (RRM) measurement criterion). If the measurement criterion for a stationary terminal device is met, the terminal device 110 may deactivate or reduce capabilities of an AI model.

In some embodiments, the network device 120 may provide a stationary measurement criterion to the terminal device 110 for evaluating AI model activation or deactivation. For example, a relaxed measurement criterion for a stationary UE may be provided as below.

Relaxed measurement criterion for a stationary UE

The relaxed measurement criterion for a stationary UE is met when:

| | |
|---|---|
| - | (Srxlev_{RefStationaryConnected} − Srxlev) < S_{SearchDeltaP-StationaryConnected}, |

Where:

| - | Srxlev = current Srxlev value of the PCell cell (dB). | |
|---|---|---|
| - | Srxlev_{RefStationaryConnected} = reference Srxlev value of the PCell cell (dB), set as follows: | |
| | - | At the end of RRC reconfiguration procedure as specified in 5.3.5.3, when rrm- |
| | | MeasRelaxationReportingConfig is included in the RRCReconfiguration message; or |
| | - | If (Srxlev − Srxlev_{RefStationaryConnected}) > 0; or |
| | - | If the relaxed measurement criterion has not been met for T_{SearchDeltaP-StationaryConnected}: |

| | |
|---|---|
| - | The UE shall set the value of Srxlev_{RefStationaryConnected} to the current Srxlev value of the serving cell. |

It is to be understood that any other suitable stationary measurement criterions are also feasible.

In some embodiments, the network device 120 may transmit a RRC message (e.g., rrm-MeasRelaxationReportingConfig within a RRCReconfiguration message) comprising an indication IE (e.g., usedForAIEvaluation) and the indication IE may indicate whether the terminal device 110 needs to use the stationary measurement criterion to evaluate the AI model. For example, an example configuration may be designed as below.

RRM-MeasRelaxationReportingConfig-r17 ::= SEQUENCE {

| | |
|---|---|
| usedForAIEvaluation | BOOLEAN / ENUMERATED (true) |
| s-SearchDeltaP-Stationary-r17 | ENUMERATED {dB3, dB6, dB9, dB12, dB15, spare3, spare2, spare1}, |
| t-SearchDeltaF-Stationery-r17 | ENUMERATED {s5, s10, s20, s30, s60, s120, s180, s240, s300, spare7, spare6, spare5, |
| | spare4, spare3, spare2, spare1} |

}

In some embodiments, when the terminal device 110 meets the stationary measurement criterion for a period of T_{SearchDeltaP-SationaryConnected}, i.e., the signal channel is stable, the terminal device 110 may deactivate or reduce the capabilities of the AI model.

In some embodiments, the terminal device 110 may introduce an IE AIReport into UAI used to report information of the current expected AI model to the network device 120. In some embodiments, a cause (e.g., RRMRclax) may be introduced into the IE AIReport to indicate which cause to initiate the UAI transmission. For example, example UAI may be designed as below.

UEAssistanceInformation-v1xxx-IEs ::= SEQUENCE {

| | |
|---|---|
| aiReport | AIReport |
| nonCriticalExtension | UEAssistanceInformation-v1xxx-IEs |

}

| | |
|---|---|
| AIRport ::= | SEQUENCE { |
| (opt1)deactivation | BOOLEAN / ENUMERATED {true} |
| (opt2)deactivationList | SEQUENCE(SIZE(1...N))OF deactivationPart |
| reducedList | SEQUENCE(SIZE(1...N))OF redecuedPart |
| cause | ENUMERATED {RRMRelax, RLMRelax, s-Measure, Overheating, RLF...} |

}

In this example, deactivation denotes that all capabilities of the AI model are deactivated, and deactivationList denotes a part of capabilities of the AI model (e.g., AI model inference, AI model training, AI model monitor, AI mode updating, or data collection) is deactivated. ReduceList denotes 1) switch AI model; 2) reduce AI output accuracy requirement; 3) reduce computing latency requirement; or 4) reduce a period of an AI model monitor.

For example, an example procedure may be described as below.

### Part 1

Upon AI model is deployed, the UE shall:
When reception of an RRCReconfiguration by the UE:
1> if the RRCReconfiguration includes the rrm-MeasRelaxationReportingConfig:
   2> if the indication of usedForAIEvaluation (positive value) is included (in dedicated RRC signal):
      3> perform measurements based on the stationary measurement criterion for evaluating AI model.

### Part 2

1> if the stationary measurement criterion is met for a period of TSearchDeltaP-StationaryConnected: (further explanation: UE is in RRM relaxation state)
   (opt1) 2> deactivate the AI model (could be the whole or part of AI function, e.g. inference, data collection, training, monitor, updating);
   (opt2) 2> reduce the AI model capabilities (could be e.g. switch to simple model, reduce requirement of accuracy and/or latency, reduce the period of model monitor);
   2> if configured to provide AIReport assistance information:
      3> if the UE did not transmit a UEAssistanceInformation message with AIReport since it was configured to provide; or
      3> if the current AIReport is different from the one indicated in the last transmission of the UEAssistanceInformation message including AIReport and the prohibit timer is not running:
         4> start the prohibit timer with the timer value is set to Txxx;
         4> initiate transmission of the UEAssistanceInformation message to provide AIReport.

### Part 3

1> if the transmission of the UEAssistanceInformation message is initiated to provide AIReport:
   2> if the UE prefers to deactivate the AI model:
      3> include (opt1) deactivation or (opt2) deactivationList in the AIReport IE;
   2> if the UE prefers to reduce the AI model capabilities:
      3> include reducedList in the AIReport IE:
   2> if cause is configured to provide:
      3> set the cause to RRMRelax:
   2> else (i.e. UE resume AI model):
      3> do not include (opt1) deactivation or (opt2) deactivationList, reducedList, cause in the AIReport IE;
1> submit the UEAssistanceInformation message to lower layers for transmission.

### Embodiment 2

In this embodiment, the signal measurement criterion is at least one of a measurement criterion for low mobility or a measurement criterion for good serving cell quality (i.e., a radio link management (RLM) measurement criterion). If the at least one of the measurement criterion for low mobility or the measurement criterion for good serving cell quality is met, the terminal device 110 may deactivate or reduce capabilities of an AI model.

In some embodiments, the network device 120 may provide at least one of a measurement criterion for low mobility or a measurement criterion for good serving cell quality to the terminal device 110 for evaluating AI model activation or deactivation. For example, a relaxed measurement criterion for low mobility may be provided as below.

Relaxed measurement criterion for low mobility

The relaxed measurement criterion for UE with low mobility in RRC_CONNECTED is fulfilled when:

| | |
|---|---|
| - | (SS-RSRP_{Ref} − SS-RSRP) < S_{SearchDeltaP-Connected,} |

Where:

| - | SS-RSRP = current L3 RSRP measurement of the SpCell based on SSB (dB). | |
|---|---|---|
| - | SS-RSRP_{Ref} = reference L3 RSRP measurement of the SpCell based on SSB (dB), set as follows: | |
| | - | After receiving low mobility criterion configuration, or |
| | - | After MAC of the CG successfully completes a Random Access procedure after applying a |
| | | reconfigurationWithSync in spCellConfig of the CG while low mobility criterion is configured, or |
| | - | If (SS-RSRP − SS-RSRP_{Ref}) > 0, or |
| | - | If the relaxed measurement criterion has not been met for T_{SearchDeltaP-Connected}: |

| | |
|---|---|
| - | The UE shall set the value of SS-RSRP_{Ref} to the current SS-RSRP value of the SpCell. |

For example, a relaxed measurement criterion for good serving cell quality may be provided as below.

Relaxed measurement criterion for good serving cell quality

The relaxed measurement criterion of good serving cell quality for RLM starts to be evaluated after receiving the good
serving cell quality criterion configuration and is fulfilled when the downlink radio link quality on the configured RLM-
RS resource is evaluated to be better than the threshold Qᵢₙ+XdB, wherein

| | |
|---|---|
| - | Qᵢₙ is specified in clause 8.1 of TS 38.133 [14]. |
| - | X is the parameter offset in goodServingCellEvaluationRLM. |

It is to be understood that any other suitable measurement criterions for low mobility or good serving cell quality are also feasible.

In some embodiments, the network device 120 may transmit a RRC message (e.g., rrm-MeasRelaxationReportingConfig within a RRCReconfiguration message) comprising an indication IE (e.g., usedForAIEvaluation) and the indication IE may indicate whether the terminal device 110 needs to use at least one of the measurement criterion for low mobility or the measurement criterion for good serving cell quality to evaluate the AI model.

In some embodiments, when the terminal device 110 meets the measurement criterion for low mobility for a period of T_{SearchDeltaP-Connected}, the terminal device 110 may deactivate or reduce the capabilities of the AI model. In some embodiments, when the terminal device 110 meets the measurement criterion for good serving cell quality, the terminal device 110 may deactivate or reduce the capabilities of the AI model. In some embodiments, when the terminal device 110 meets the measurement criterion for low mobility for a period of T_{SearchDeltaP-Connected} and the measurement criterion for good serving cell quality, i.e., the signal channel is stable (due to low mobility) and good enough (due to good serving cell quality), the terminal device 110 may deactivate or reduce the capabilities of the AI model.

In some embodiments, the terminal device 110 may introduce an IE AIReport into UAI used to report information of the current expected AI model to the network device 120. In some embodiments, a cause (e.g., RLMRelax) may be introduced into the IE AIReport to indicate which cause to initiate the UAI transmission. For example, example UAI may be designed as below.

BOOLEAN / ENUMERATED {true} -

UEAssistanceInformation-v1xxx-IEs ::= SEQUENCE {

| | |
|---|---|
| aiReport | AIReport |
| nonCriticalExtension | UEAssistanceInformation-v1xxx-IEs |

}

| | |
|---|---|
| AIRport ::= | SEQUENCE { |
| (opt1)deactivation | BOOLEAN / ENUMERATED {true} |
| (opt2)deactivationList | SEQUENCE(SIZE(1...N))OF deactivationPart |
| reducedList | SEQUENCE(SIZE(1...N))OF redecuedPart |
| cause | ENUMERATED {RRMRelax, RLMRelax, s-Measure, Overheating, RLF...} |

}

In this example, deactivation denotes that all capabilities of the AI model are deactivated, and deactivationList denotes a part of capabilities of the AI model (e.g., AI model inference, AI model training, AI model monitor, AI mode updating, or data collection) is deactivated. ReduceList denotes 1) switch AI model; 2) reduce AI output accuracy requirement; 3) reduce computing latency requirement; or 4) reduce a period of an AI model monitor.

For example, an example procedure may be described as below.

### Part 1

Upon AI model is deployed, the UE shall:

When reception of an RRCReconfiguration by the UE:
1> if the RRCReconfiguration includes the mii-MeasRelaxationReportingConfig:
   2> if the indication of usedForAIEvaluation (positive value) is included (in dedicated RRC signal):
      3> perform measurements based on the low mobility measurement criterion (if configured) and/or the good serving cell quality criterion (if configured) for evaluating AI model.

### Part 2

1> if the low mobility measurement criterion is met for a period of TSearchDeltaP-Connected; and/or
1> if the good serving cell quality criterion is met: (further explanation: UE is in RLM relaxation state)
   (opt1) 2> deactivate the AI model (could be the whole or part of AI function. e.g. inference, data collection, training, monitor, updating);
   (opt2) 2> reduce the AI model capabilities (could be e.g. switch to simple model, reduce requirement of accuracy and/or latency, reduce the period of model monitor);
   2> if configured to provide AIReport assistance information:
      3> if the UE did not transmit a UEAssistanceInformation message with AIReport since it was configured to provide; or
      3> if the current AIReport is different from the one indicated in the last transmission of the UEAssistanceInformation message including AIReport and the prohibit timer is not running:
         4> start the prohibit timer with the timer value is set to Txxx;
         4> initiate transmission of the UEAssistanceInformation message to provide AIReport.

### Part 3

1> if the transmission of the UEAssistanceInformation message is initiated to provide AIReport:
   2> if the UE prefers to deactivate the AI model:
      3> include (opt1) deactivation or (opt2) deactivationList in the AIReport IE;
   2> if the UE prefers to reduce the AI model capabilities:
      3> include reducedList in the AIReport IE:
   2> if cause is configured to provide:
      3> set the cause to RLMRelax;
   2> else (i.e. UE resume AI model):
      3> do not include (opt1) deactivation or (opt2) deactivationList, reducedList, cause in the AIReport IE;
1> submit the UEAssistanceInformation message to lower layers for transmission.

### Embodiment 3

In this embodiment, the signal measurement criterion is an s-measure criterion. If the s-measure criterion is met, the terminal device 110 may deactivate or reduce capabilities of an AI model.

In some embodiments, the network device 120 may provide an s-measure criterion to the terminal device 110 for evaluating AI model activation or deactivation.

In some embodiments, the network device 120 may transmit a RRC message (e.g., measConfig within a RRCReconfiguration message) comprising an indication IE (e.g., usedForAlEvaluation) and the indication IE may indicate whether the terminal device 110 needs to use the s-measure criterion to evaluate the AI model.

In some embodiments, the terminal device 110 may introduce an IE AIReport into UAI used to report information of the current expected AI model to the network device 120. In some embodiments, a cause (e.g., S-measure) may be introduced into the IE AIReport to indicate which cause to initiate the UAI transmission. For example, example UAI may be designed as below.

UEAssistanceInformation-v1xxx-IEs ::= SEQUENCE {

| | |
|---|---|
| aiReport | AIReport |
| nonCriticalExtension | UEAssistanceInformation-v1xxx-IEs |

}

| | |
|---|---|
| AIRport ::= | SEQUENCE { |
| (opt1)deactivation | BOOLEAN / ENUMERATED {true} |
| (opt2)deactivationList | SEQUENCE(SIZE(1...N))OF deactivationPart |
| reducedList | SEQUENCE(SIZE(1...N))OF redecuedPart |
| cause | ENUMERATED {RRMRelax, RLMRelax, s-Measure, Overheating, RLF...} |

}

In this example, deactivation denotes that all capabilities of the AI model are deactivated, and deactivationList denotes a part of capabilities of the AI model (e.g., AI model inference, AI model training, AI model monitor, AI mode updating, or data collection) is deactivated. ReduceList denotes 1) switch AI model; 2) reduce AI output accuracy requirement; 3) reduce computing latency requirement; or 4) reduce a period of an A model monitor.

For example, an example procedure may be described as below.

### Part 1

When performing measurements in RRC_CONNECTED, the UE shall:
1> if s-MeasureConfig is configured and the indication usedForAIEvaluation (positive value) is included in RRC signal (e.g. measConfig):
   2> if s-MeasureConfig is set to ssb-RSRP and the SpCell RSRP based on SS/PBCH block, after layer 3 filtering, is above ssb-RSRP, or
   2> if s-MeasureConfig is set to csi-RSRP and the SpCell RSRP based on CSI-RS, after layer 3 filtering, is above csi-RSRP:
      (opt1) 3> deactivate the AI model (could be the whole or part of AI function, e.g. inference, data collection, training, monitor, updating);
      (opt2) 3> reduce the AI model capabilities (could be e.g. switch to simple model, reduce requirement of accuracy and/or latency, reduce the period of model monitor);
      3> if configured to provide AIReport assistance information:
         4> if the UE did not transmit a UEAssistanceInformation message with AIReport since it was configured to provide; or
         4> if the current AIReport is different from the one indicated in the last transmission of the UEAssistanceInformation message including AIReport and the prohibit timer is not running:
         5> start the prohibit timer with the timer value is set to Txxx;
         5> initiate transmission of the UEAssistanceInformation message to provide AIReport.

### Part 2

1> if the transmission of the UEAssistanceInformation message is initiated to provide AIReport:
   2> if the UE prefers to deactivate the AI model:
      3> include (opt1) deactivation or (opt2) deactivationList in the AIReport IE;
   2> if the UE prefers to reduce the AI model capabilities:
      3> include reducedList in the AIReport IE:
   2> if cause is configured to provide:
      3> set the cause to s-Measure;
   2> else (i.e. UE resume AI model):
      3> do not include (opt1) deactivation or (opt2) deactivationList, reducedList, cause in the AIReport IE;
1> submit the UEAssistanceInformation message to lower layers for transmission.

### 2. Overheating Based Method

In some embodiments, the event is that an overheating condition is detected. In some embodiments, if internal overheating of the terminal device 110 is detected, the terminal device 110 may deactivate or reduce capabilities of the AI model. In this way, since AI computing may cause overheating, the AI model may be deactivated or reduced to protect a terminal device from overheating impact.

In some embodiments, the terminal device 110 may introduce an IE AIReport into UAI used to report information of the current expected AI model to the network device 120. In some embodiments, a cause (e.g., overheating) may be introduced into the IE AIReport to indicate which cause to initiate the UAI transmission. For example, example UAI may be designed as below.

UEAssistanceInformation-v1xxx-IEs ::= SEQUENCE {

| | |
|---|---|
| aiReport | AIReport |
| nonCriticalExtension | UEAssistanceInformation-v1xxx-IEs |

}

| | |
|---|---|
| AIRport ::= | SEQUENCE { |
| (opt1)deactivation | BOOLEAN / ENUMERATED {true} |
| (opt2)deactivationList | SEQUENCE(SIZE(1...N))OF deactivationPart |
| reducedList | SEQUENCE(SIZE(1...N))OF redecuedPart |
| cause | ENUMERATED {RRMRelax, RLMRelax, s-Measure, Overheating, RLF...} |

}

In this example, deactivation denotes that all capabilities of the AI model are deactivated, and deactivation List denotes a part of capabilities of the AI model (e.g., AI model inference, AI model training, AI model monitor, AI mode updating, or data collection) is deactivated. ReduceList denotes 1) switch AI model; 2) reduce AI output accuracy requirement; 3) reduce computing latency requirement; or 4) reduce a period of an A model monitor.

For example, an example procedure may be described as below.

### Part 1

Upon AI model is deployed, the UE shall:
1> if the overheating condition has been detected:
   (opt1) 2> deactivate the AI model (could be the whole or part of AI function, e.g. inference, data collection, training, monitor, updating);
   (opt2) 2> reduce the AI model capabilities based on reducedPart (could be e.g. switch to simple model, reduce requirement of accuracy and/or latency, reduce the period of model monitor);
   2> if configured to provide AIReport assistance information:
      3> if the UE did not transmit a UEAssistanceInformation message with AIReport since it was configured to provide; or
      3> if the current AIReport is different from the one indicated in the last transmission of the UEAssistanceInformation message including AIReport and the prohibit timer is not running:
         4> start the prohibit timer with the timer value is set to Txxx;
         4> initiate transmission of the UEAssistanceInformation message to provide AIReport.

### Part 2

1> if the transmission of the UEAssistanceInformation message is initiated to provide AIReport:
   2> if the UE prefers to deactivate the AI model:
      3> include (opt1) deactivation or (opt2) deactivationList in the AIReport IE;
   2> if the UE prefers to reduce the AI model capabilities:
      3> include reducedList in the AIReport IE:
   2> if cause is configured to provide:
      3> set the cause to overheating;
   2> else (i.e. UE resume AI model):
      3> do not include (opt1) deactivation or (opt2) deactivationList, reducedList, cause in the AIReport IE;
1> submit the UEAssistanceInformation message to lower layers for transmission.

In some alternative embodiments, the terminal device 110 may directly use overheating assistance information instead of UAI with an IE AIReport. For example, an example overheating assistance information may be designed as below.

| | |
|---|---|
| OverheatingAssistance ::= | SEQUENCE { |
| reducedMaxCCs | ReducedMaxCCs-r16 |
| reducedMaxBW-FR1 | ReducedMaxBW-FRx-r16 |
| reducedMaxBW-FR2 | ReducedMaxBW-FRx-r16 |
| reducedMaxMIMO-LayersFR1 | SEQUENCE { |
| reducedMIMO-LayersFR1-DL | MIMO-LayersDL, |
| reducedMIMO-LayersFR1-UL | MIMO-LayersUL |
| } | |
| reducedMaxMIMO-LayersFR2 | SEQUENCE { |
| reducedMIMO-LayersFR2-DL | MIMO-LayersDL, |
| reducedMIMO-LayersFR2-UL | MIMO-LayersUL |

}

| | |
|---|---|
| (opt1)aideactivation | BOOLEAN / ENUMERATED {true} |
| (opt2)aideactivationList | SEQUENCE(SIZE(1...N))OF deactivationPart |
| aiReducedList | SEQUENCE(SIZE(1...N))OF redecuedPart |

}

In this example, aideactivation denotes that all capabilities of the AI model are deactivated, and aideactivationList denotes a part of capabilities of the AI model (e.g., AI model inference, AI model training, AI model monitor, AI mode updating, or data collection) is deactivated. aiReduceList denotes 1) switch AI model; 2) reduce AI output accuracy requirement; 3) reduce computing latency requirement; or 4) reduce a period of an AI model monitor.

For example, an example procedure may be described as below.

### Part 1

Upon AI model is deployed, the UE shall:
1> if configured to provide overheating assistance information:
   2> if the overheating has been detected:
      (opt1) 3> deactivate the AI model (could be the whole or part of AI function, e.g. inference, data collection, training, monitor, updating);
      (opt2) 3> reduce the AI model capabilities (could be e.g. switch to simple model, reduce requirement of accuracy and/or latency, reduce the period of model monitor);
   2> if the overheating condition has been detected and T345 is not running; or
   2> if the current overheating assistance information is different from the one indicated in the last transmission of the UEAssistanceInformation message including overheatingAssistance and timer T345 is not running:
      3> start timer T345 with the timer value set to the overheatingIndicationProhibitTimer;
      3> initiate transmission of the UEAssistanceInformation message in accordance with 5.7.4.3 to provide overheating assistance information.

### Part 2

1> if transmission of the UEAssistanceInformation message is initiated to provide overheating assistance information;
   2> if the UE experiences internal overheating:
      3> if the UE prefers to temporarily reduce the number of maximum secondary component carriers:
         4> omit part . . .
      3> if the UE prefers to temporarily reduce maximum aggregated bandwidth of FR1:
         4> omit part . . .
      3> if the UE prefers to deactivate the AI model:
         4> include (opt1) aideactivation or (opt2) aideactivationList in the OverheatingAssistance IE;
      3> if the UE prefers to reduce the AI model capabilities:
         4> include aireducedList in the OverheatingAssistance IE;
   2> else (if the UE no longer experiences an overheating condition):
      3> do not include (opt1) aideactivation/(opt2) aideactivationList, aireducedList, reducedMaxCCs, reducedMaxBW-FR1, reducedMaxBW-FR2, reducedMaxBW-FR2-2, reducedMaxMIMO-LayersFR1, reducedMaxMIMO-LayersFR2 and reducedMaxMIMO-LayersFR2-2 in OverheatingAssistance IE;
1> submit the UEAssistanceInformation message to lower layers for transmission.

### 3. RLF Based Method

In some embodiments, the event is that a RLF is detected. In some embodiments, if a RLF happens, the terminal device 110 may deactivate or reduce capabilities of the AI model. In this way, if RLF happens when using an AI model, probably means AI prediction is not accurate, so that deactivating or reducing the AI model for better performance.

In some embodiments, the terminal device 110 may introduce an IE AIReport into UAI used to report information of the current expected AI model to the network device 120. In some embodiments, a cause (e.g., RLF) may be introduced into the IE AIReport to indicate which cause to initiate the UAI transmission. For example, example UAI may be designed as below.

UEAssistanceInformation-v1xxx-IEs ::= SEQUENCE {

| | |
|---|---|
| aiReport | AIReport |
| nonCriticalExtension | UEAssistanceInformation-v1xxx-IEs |

}

| | |
|---|---|
| AIRport ::= | SEQUENCE { |
| (opt1)deactivation | BOOLEAN / ENUMERATED {true} |
| (opt2)deactivationList | SEQUENCE(SIZE(1...N))OF deactivationPart |
| reducedList | SEQUENCE(SIZE(1...N))OF redecuedPart |
| cause | ENUMERATED {RRMRelax, RUMRelax, s-Measure, Overheating, RLF...} |

}

In this example, deactivation denotes that all capabilities of the AI model are deactivated, and deactivationList denotes a part of capabilities of the AI model (e.g., AI model inference, AI model training, AI model monitor, AI mode updating, or data collection) is deactivated. ReduceList denotes 1) switch AI model; 2) reduce AI output accuracy requirement; 3) reduce computing latency requirement; or 4) reduce a period of an A model monitor.

For example, an example procedure may be described as below.

### Part 1

1> if the UE considers radio link failure to be detected (i.e. RLF):
   (opt1) 2> deactivate the AI model (could be the whole or part of AI function, e.g. inference, data collection, training, monitor, updating);
   (opt2) 2> reduce the AI model capabilities (could be e.g. switch to simple model, reduce requirement of accuracy and/or latency, reduce the period of model monitor);
      2> if configured to provide AIReport assistance information:
         3> if the UE did not transmit a UEAssistanceInformation message with AIReport since it was configured to provide; or
         3> if the current AIReport is different from the one indicated in the last transmission of the UEAssistanceInformation message including AIReport and the prohibit timer is not running:
         4> start the prohibit timer with the timer value is set to Txxx;
         4> initiate transmission of the UEAssistanceInformation message to provide AIReport.

### Part 2

1> if the transmission of the UEAssistanceInformation message is initiated to provide AIReport:
   2> if the UE prefers to deactivate the AI model:
      3> include (opt1) deactivation or (opt2) deactivationList in the AIReport IE;
   2> if the UE prefers to reduce the AI model capabilities:
      3> include reducedList in the AIReport IE:
   2> if cause is configured to provide:
      3> set the cause to RLF;
   2> else (i.e. UE resume AI model):
      3> do not include (opt1) deactivation or (opt2) deactivationList, reducedList, cause in the AIReport IE;
1> submit the UEAssistanceInformation message to lower layers for transmission.

### 4. Dedicated RRC Signal Based Method

In some embodiments, the event is that an indication (i.e., the first indication) of the deactivation or reduction of capabilities of an AI model is received from a network. In some embodiments, the network device 120 may directly notify the terminal device 110 of deactivating or reducing capabilities of the AI model. In this way, an implementation based method may be provided for network control.

In some embodiments, the network device 120 may introduce an indication of AI model state into a dedicated RRC signal (e.g., RRC reconfiguration message) so as to reconfigure the AI model function or activate/deactivate the AI model. For example, an example dedicated RRC signal may be designed as below.

| | |
|---|---|
| Dedicated RRC signal for AI model::= | SEQUENCE { |
| (opt1)deactivation | BOOLEAN / ENUMERATED {true} |
| (opt2)deactivationList | SEQUENCE(SIZE(1...N))OF deactivationPart |
| (opt1)activation | BOOLEAN / ENUMERATED {true} |
| (opt2)activationList | SEQUENCE(SIZE(1...N))OF activationPart |
| reducedList | SEQUENCE(SIZE(1...N))OF redecuedPart |

}

In this example, deactivation denotes that all capabilities of the AI model a s deactivated, and deactivationList denotes a part of capabilities of the AI model (e.g., AI model inference, AI model training, AI model monitor, AI mode updating, or data collection) is deactivated. In addition, activation denotes that all capabilities of the AI model are activated, and activationList denotes a part of capabilities of the AI model (e.g., AI model inference, AI model training, AI model monitor, AI mode updating, or data collection) is activated. Furthermore, reduceList denotes 1) switch AI model; 2) reduce AI output accuracy requirement; 3) reduce computing latency requirement; or 4) reduce a period of an AI model monitor.

In some embodiments, the network device 120 may set reducedList to be null. In this way, the network device 120 may resume some AI functions which are already performed previously.

For example, an example procedure may be described as below.

When reception of dedicated RRC signal for AI model, the UE shall:
1> if the indication of deactivation (or deactivationList) is included:
   2> deactivate the AI model based on the indication (could be the whole or part of AI function, e.g. inference, data collection, training, monitor, updating);
1> if the indication of activation (or activationList) is included:
   2> activate the AI model based on the indication (could be the whole or part of AI function, e.g. inference, data collection, training, monitor, updating);
1> if the reducedList is included:
   2> if no reducedPart is included:
      3> resume the previous reduced AI model capabilities;
   2> else:
      3> reduce the AI model based on reducedPart (could be e.g. switch to simple model, reduce requirement of accuracy and/or latency, reduce the period of model monitor).

### 5. RRC Release Based Method

In some embodiments, the event is that the terminal device 110 enters an idle or inactive state. In some embodiments, when the terminal device 110 enters an idle or inactive state, the terminal device 110 may deactivate or reduce capabilities of the AI model. There is no strong need for AI evaluation during an idle or inactive state. Thus, stopping the AI model may achieve power saving.

In some embodiments, the network device 120 may introduce information (for convenience, also referred to as third information herein) of AI model into a RRC release message so as to reconfigure the AI model function or activate/deactivate the AI model. For example, an example RRC release message may be designed as below.

| RRCRelease-IEs ::= | SEQUENCE { |
|---|---|
| indicationOfAIMoel | IndicationOfAIModel |
| } | |
| IndicationOfAIModel ::= | SEQUENCE { |
| (opt1)deactivation | BOOLEAN / ENUMERATED {true} |
| (opt2)deactivationList | SEQUENCE(SIZE(1...N))OF deactivationPart |
| (opt1)activation | BOOLEAN / ENUMERATED {true} |
| (opt2)activationList | SEQUENCE(SIZE(1...N))OF activationPart |
| reducedList | SEQUENCE(SIZE(1...N))OF redecuedPart |
| loggedAIMeasurement | BOOLEAN / ENUMERATED {true} |

}

In this example, deactivation denotes that all capabilities of the AI model are deactivated, and deactivationList denotes a part of capabilities of the AI model (e.g., AI model inference, AI model training, AI model monitor, AI mode updating, or data collection) is deactivated. In addition, activation denotes that all capabilities of the AI model are activated, and activationList denotes a part of capabilities of the AI model (e.g., AI model inference, AI model training, AI model monitor, AI mode updating, or data collection) is activated. Furthermore, reduceList denotes 1) switch AI model; 2) reduce AI output accuracy requirement; 3) reduce computing latency requirement; or 4) reduce a period of an AI model monitor. In addition to the above contents, the information of AI model may also comprise a logged measurement (loggedAIMeasurement) which is used to notify the terminal device 110 of still performing AI model upon entering an idle or inactive state. In this way, logged AI measurement may be processed for better network control.

In some embodiments, the terminal device 110 may receive a RRC release message comprising the third information of the AI model. In some embodiments, if the third information comprises an indication indicating a logged measurement, the terminal device 110 may continue to perform actions related to the AI model upon entering the idle or inactive state. In some embodiments, if the third information comprises an indication indicating deactivation of the capabilities of the AI model, the terminal device 110 may deactivate the capabilities of the artificial intelligence model based on the third information. In some embodiments, if the third information comprises an indication indicating the activation of the capabilities of the AI model, the terminal device 110 may activate the capabilities of the AI model based on the third information. In some embodiments, if the third information comprises an indication indicating reduction of capabilities of the AI model, the terminal device 110 may reduce the capabilities of the AI model based on the third information.

For example, an example procedure may be described as below.

When UE enters RRC_IDLE or RRC_INACTIVE, the UE shall:
1> deactivate the whole AI model.

In another example, an example procedure may be described as below.

When UE enters RRC_IDLE or RRC_INACTIVE, the UE shall:
1> if the RRCRelease message includes the IndicationOfAIModel:
   2> if the loggedAIMeasurement is included:
      3> UE continue performing actions related AI model when enters RRC_IDLE/INACTIVE;
   2> if the indication of deactivation (or deactivationList) is included:
      3> deactivate the AI model based on the indication (could be the whole or part of AI function, e.g. inference, data collection, training, monitor, updating) when enters RRC_IDLE/INACTIVE;
   2> if the indication of activation (or activationList) is included:
      3> activate the AI model based on the indication (could be the whole or part of AI function, e.g. inference, data collection, training, monitor, updating) when enters RRC_IDLE/INACTIVE;
   2> if the reducedList is included:
      3> reduce the AI model based on reducedPart (could be e.g. switch to simple model, reduce requirement of accuracy and/or latency, reduce the period of model monitor) when enters RRC_IDLE/INACTIVE;
1> enter RRC_IDLE or RRC_INACTIVE.

### 6. Handover Based Method

In some embodiments, the event is that a handover to a target cell is to be performed and an AI model associated with the target cell is specific to a cell. In some embodiments, when a handover to a target cell happens, whether to still use the AI model is determined by an indication indicating whether the target is specific to a cell or an area. In this way, a terminal device may know situation of the AI model.

In some embodiments, a network device (e.g., the network device 120 or 130) may introduce an indication (for convenience, also referred to as a third indication herein) indicating that an AI model associated with a cell (e.g., the cell 121 or 131) provided by the network device is specific to a cell or an area. In some embodiments, the third indication may be carried in system information from the network device. In some embodiments, the third indication may be carried in a RRC message from the network device, for example, a RRC setup message, a RRC reconfiguration message or any other suitable messages.

In some embodiments where the cell 121 is a source cell and the cell 131 is a target cell, if the terminal device 110 receives the third indication from the network device 130 indicating that an AI model associated with the cell 131 is specific to a cell, the terminal device 110 may deactivate or reduce capabilities of the AI model associated with the cell 121. If the third indication indicates that an AI model associated with the cell 131 is specific to an area and the cell 131 belongs to the area, the terminal device 110 may continue to perform actions related to the AI model associated with the cell 121.

In some embodiments, upon determination of a handover to a target cell (e.g., the cell 131), the network device 120 may transmit, to a further network device (e.g., the network device 130) providing the target cell, information that the AI model associated with the cell 121 is specific to a cell or an area. In some embodiments, such information may be carried in a handover request message. This may assist for a target gNB to optimize a configuration.

In some embodiments, the further network device may transmit, to the network device 120, information that an AI model associated with the target cell is specific to a cell or an area. In some embodiments, such information may be carried in a handover request acknowledgement message. This may assist for a source gNB to optimize a configuration.

In some embodiments, if information of a further AI model is received during a handover (e.g., via a RRC reconfiguration message or a RRC setup message), the terminal device 110 may replace the AI model associated with a source cell (e.g., the cell 121) with the further AI model.

For example, an example procedure may be described as below.

When UE handover to a target cell, based on the AI indication, the UE shall:
1> if the AI indication is set to cell-specific:
   2> the UE stop using the previous AI model;
1> if the AI indication is set to area-specific:
   2> the UE may continue performing actions related to the AI model when connects with the target cell belonging to the area.

In another example, an example procedure may be described as below.

When receive a new AI model from the dedicated RRC signal (e.g. RRCReconfiguration/RRCSetup) during handover procedure, the UE shall:
1> replace the previous AI model with the new one.

It is to be understood that the above embodiments may be used separately or in any suitable combination. So far, a solution of disabling or enabling an AI model is described. In this way, mobility management may be improved and power saving may be achieved.

### Example Implementation of Measurement Reporting

Embodiments of the present disclosure also provide another solution for management of an AI model. In the solution, a terminal device transmits a measurement report comprising information associated with an AI model. In this way, information of an AI model may be reported to a network for a better decision of mobility management.

FIG. 3 illustrates a schematic diagram illustrating another process 300 of communication according to embodiments of the present disclosure. For the purpose of discussion, the process 300 will be described with reference to FIG. 1. The process 300 may involve the terminal device 110 and the network device 120 as illustrated in FIG. 1. It is assumed that the terminal device 110 is located in the cell 121 and served by the network device 120. The terminal device 110 supports an AI model.

With reference to FIG. 3, the terminal device 110 transmits 310, to the network device 120, a measurement report comprising information associated with an AI model.

In some embodiments, the terminal device 110 may determine 311 whether the measurement report is triggered by the AI model. If the measurement report is triggered by the AI model, the terminal device 110 may transmit 312, to the network device 120, the measurement report comprising an indication that the measurement report is triggered by the AI model. For example, a measurement report may be designed as below.

| MeasResults ::= | SEQUENCE { |
|---|---|
| measId | MeasId, |
| aiTriggered | ENUMERATED {true} |
| measResultServingMOList | MeasResultServMOList, |
| measResultNeighCells | CHOICE { |
| measResultListNR | MeasResultListNR, |
| ..., | |
| measResultListEUTRA | MeasResultListEUTRA, |
| measResultListUTRA-FDD-r16 | MeasResultListUTRA-FDD-r16, |
| sl-MeasResultsCandRelay-r17 | SL-MeasResultsRelay-r17 |

```
  }
  ...,
}
```

In this example, an indication aiTriggered is introduced into an IE MeasResults within a measurement report. If the indication is configured with true, it is shown that the measurement report is initiated by an AI model (e.g., without using a timer to trigger (TTT) to evaluate measurement events).

For example, an example procedure may be described as below.

When reception of measConfig, the UE shall perform measurements based on measurement identities (measID), measurement objects and reporting configurations.
1> For the measId for which the measurement reporting procedure was triggered, the UE shall set the measResults within the MeasurementReport message as follows:
   2> if this is the AI model triggering that including a measurement reporting entry within the VarMeasReportList for this measId:
      3> include aiTriggered with the value set to true into MeasResults when transmission of the measurement report.

In some embodiments, the terminal device 110 may receive 313, in system information from the network device 120, AI model information of a set of neighbor cells. The AI mode information may at least indicate that a corresponding cell supports an AI mode.

In some embodiments where a measurement report is to be transmitted, the terminal device 110 may determine 314, based on the AI model information, whether a cell indicated in the measurement report supports the AI model. If the cell supports the AI model, the terminal device 110 may transmit 315 the measurement report comprising an indication indicating that the cell supports the AI model. For example, an example measurement report may be designed as below.

| | |
|---|---|
| MeasResultNR ::= | SEQUENCE { |
| physCellId | PhysCellId |
| aiCapabledCell | BOOLEAN / ENUMERATED {true} |
| measResult | SEQUENCE { |
| cellResults | SEQUENCE{ |
| resultsSSB-Cell | MeasQuantityResults |
| resultsCSI-RS-Cell | MeasQuantityResults |
| }, | |
| rsIndexResults | SEQUENCE{ |
| resultsSSB-Indexes | ResultsPerSSB-IndexList |
| resultsCST-RS-Indexes | ResultsPerCSI-RS-IndexList |

```
    }
  },
  ...,
}
```

In this example, an indication aiCapabledCell is introduced into an IE MeasResults within a measurement report. For example, if the terminal device 110 is to report a measID and a cell indicated by the measID supports an A model, the terminal device 110 may need to set the indication aiCapabledCell to true.

For example, an example procedure may be described as below.

When reception of measConfig, the UE shall perform measurements based on measurement identities (measID), measurement objects and reporting configurations.
1> For the measId for which the measurement reporting procedure was triggered, the UE shall set the measResults within the MeasurementReport message as follows:
   2> if the cell in the CellsTriggeredList within the VarMeasReportList is indicated that supporting AI (e.g. based on SI):
      3> include AITCapabledCell with the value set to true into MeasResults when transmission of the measurement report.
   2> else: (i.e. the corresponding cell not support AI)
      3> include AICapabledCell with the value set to false into MeasResults when transmission of the measurement report.

Alternatively, an event may be introduced for AI model evaluation. If the event occurs, the terminal device 110 may transmit a measurement report. In some embodiments, the event may comprise both a measurement stage and an evaluation stage. The measurement stage is used for evaluating whether a signal measurement criterion is met, e.g., whether a measurement event for RRM is triggered. The evaluation stage is used for evaluating whether a cell associated with the measurement event supports an AI model. It is to be understood that the measurement event may adopt any suitable signal measurement criteria existing or to be developed in future.

With reference to FIG. 3, in some embodiments, the terminal device 110 may determine 316 that a measurement event for RRM is triggered. The terminal device 110 may also determine 317, based on the AI model information, that a cell associated with the measurement event supports the AI model. In this case, the terminal device 110 may generate and transmit 318 a measurement report. The measurement report may comprise an indication of the cell.

For example, an example procedure may be described as below.

Network configures some measID, and the corresponding reportConfig is set to event for AI evaluation.
2> if the reportType is set to eventTriggered for AI evaluation and if the entry condition applicable for this event, i.e. the event corresponding with the eventId of the corresponding reportConfig within VarMeasConfig, is fulfilled for one or more applicable cells for all measurements after layer 3 filtering, and
2> if the triggered cell is indicated that supporting AI (e.g. based on SI):
   3> include a measurement reporting entry within the VarMeasReportList for this measId;
   3> include the concerned cell(s) in the cellsTriggeredList defined within the VarMeasReportList for this measId;
   3> initiate the measurement reporting procedure.

It is to be understood that the above embodiments may be used separately or in any suitable combination. So far, a solution of measurement reporting is described. In this way, information of an AI model may be reported to a network for a better decision of mobility management.

### Example Implementation of Methods

Corresponding to the above processes, embodiments of the present disclosure provide methods of communication implemented at a terminal device and a network device. These methods will be described below with reference to FIGS. 4 to 7.

FIG. 4 illustrates an example method 400 of communication implemented at a terminal device in accordance with some embodiments of the present disclosure. For example, the method 400 may be performed at the terminal device 110 as shown in FIG. 1. For the purpose of discussion, in the following, the method 400 will be described with reference to FIG. 1. It is to be understood that the method 400 may include additional blocks not shown and/or may omit some blocks as shown, and the scope of the present disclosure is not limited in this regard.

At block 410, the terminal device 110 determines that an event occurs. In some embodiments, the event may comprise at least one of the following: a signal measurement criterion is met; an overheating condition is detected; a RLF is detected; a first indication indicating the deactivating or reducing is received; the terminal device 110 enters an idle or inactive state; or a handover to a target cell is to be performed, an AI model associated with the target cell being specific to a cell.

In some embodiments, the signal measurement criterion may comprise at least one of the following: a measurement criterion for a stationary terminal device; a measurement criterion for low mobility; a measurement criterion for good serving cell quality; or an s-measure criterion.

In some embodiments where the event is that the signal measurement criterion is met, the terminal device 110 may receive, from the network device 120, a second indication indicating whether the terminal device needs to evaluate the AI model based on the signal measurement criterion. If the terminal device 110 needs to evaluate the AI model, the terminal device 110 may perform signal measurements based on the signal measurement criterion.

At block 420, the terminal device 110 deactivates or reduces capabilities of an AI model. In some embodiments, the terminal device 110 may deactivate all the capabilities of an AI model. In some embodiments, the terminal device 110 may deactivate a part of the capabilities of an AI model. In some embodiments, the terminal device 110 may reduce all the capabilities of an AI model. In some embodiments, the terminal device 110 may reduce a part of the capabilities of an AI model.

In some embodiments, the terminal device 110 may transmit, to the network device 120, first information indicating that the capabilities of the AI model is deactivated or reduced. In some embodiments, the terminal device 110 may start a prohibit timer upon transmission of the information. In some embodiments, the first information may comprise at least one of the following: deactivation of the capabilities of the AI model; a list of the deactivated capabilities of the AI model; a list of the reduced capabilities of the AI model; or a cause indicating the event.

In some embodiments, the terminal device 110 may transmit, to the network device 120, second information indicating that the AI model is to be resumed. In some embodiments, the terminal device 110 may transmit the second information by causing absence of the first information.

In some embodiments where the terminal device 110 enters an idle or inactive state, the terminal device 110 may receive a RRC release message comprising third information of the AI model. In some embodiments, if the third information comprises an indication indicating a logged measurement, the terminal device 110 may continue to perform actions related to the AI model upon entering the idle or inactive state. In some embodiments, if the third information comprises an indication indicating deactivation of the capabilities of the AI model, the terminal device 110 may deactivate the capabilities of the AI model based on the third information. In some embodiments, if the third information comprises an indication indicating the activation of the capabilities of the AI model, the terminal device 110 may activate the capabilities of the AI model based on the third information. In some embodiments, if the third information comprises an indication indicating reduction of capabilities of the AI model, the terminal device 110 may reduce the capabilities of the AI model based on the third information.

In some embodiments, if the handover to the target cell is to be performed and the AI model is specific to an area, the terminal device 110 may continue to perform actions related to the AI model upon connection with the target cell belonging to the area. In some embodiments, if information of a further AI model is received during the handover, the terminal device 110 may replace the AI model with the further AI model.

In some embodiments, the terminal device 110 may receive, from a further network device proving the target cell, a third indication indicating that an AI model associated with the target cell is specific to a cell or an area.

With the method 400, a terminal device may disable or enable an AI model as needed and achieve power saving.

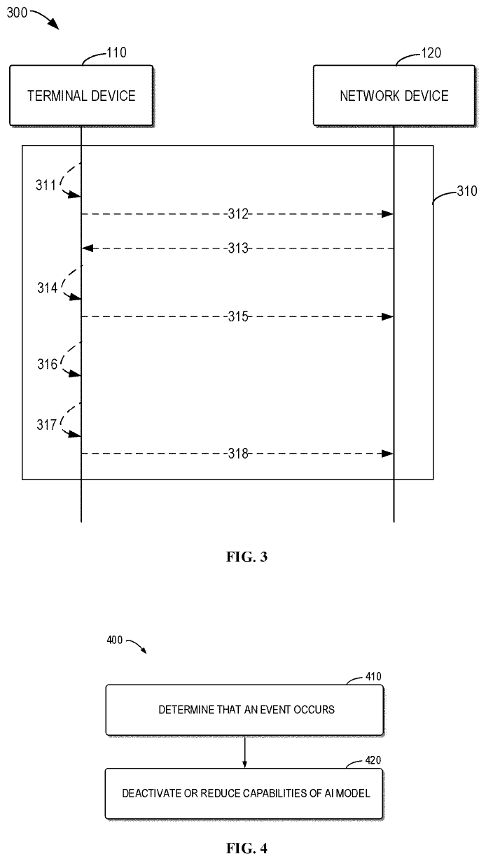

FIG. 5 illustrates another example method 500 of communication implemented at a terminal device in accordance with some embodiments of the present disclosure. For example, the method 500 may be performed at the terminal device 110 as shown in FIG. 1. For the purpose of discussion, in the following, the method 500 will be described with reference to FIG. 1. It is to be understood that the method 500 may include additional blocks not shown and/or may omit some blocks as shown, and the scope of the present disclosure is not limited in this regard.

At block 510, the terminal device 110 transmits, to the network device 120, a measurement report comprising information associated with an AI model.

In some embodiments, the terminal device 110 may determine that the measurement report is triggered by the AI model. In this case, the terminal device 110 may transmit the measurement report comprising an indication that the measurement report is triggered by the AI model.

In some embodiments, the terminal device 110 may receive, in system information from the network device 120, AI model information of a set of neighbor cells.

In some embodiments, the terminal device 110 may determine, based on the AI model information, that a cell indicated in the measurement report supports the AI model, and transmit the measurement report comprising an indication indicating that the cell supports the AI model.

In some embodiments, the terminal device 110 may determine that a measurement event for RRM is triggered, and determine, based on the AI model information, that a cell associated with the measurement event supports the AI model. In this case, the terminal device 110 may transmit a measurement report. In some embodiments, the measurement report may comprise an indication of the cell.

With the method 500, a terminal device may report information of AI model to a network for optimization of mobility management.

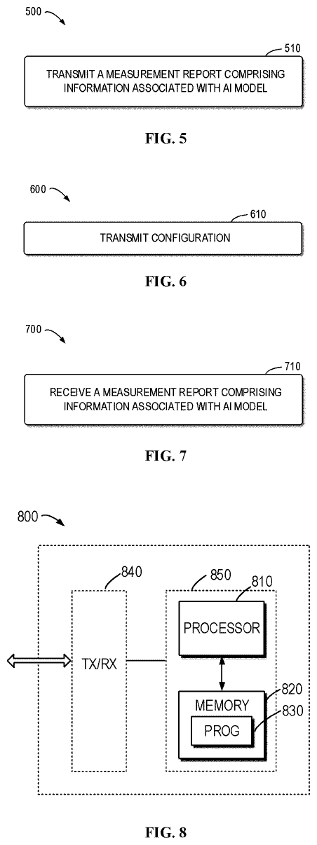

FIG. 6 illustrates an example method 600 of communication implemented at a network device in accordance with some embodiments of the present disclosure. For example, the method 600 may be performed at the network device 120 or 130 as shown in FIG. 1. For the purpose of discussion, in the following, the method 600 will be described with reference to the network device 120 in FIG. 1. It is to be understood that the method 600 may include additional blocks not shown and/or may omit some blocks as shown, and the scope of the present disclosure is not limited in this regard.

At block 610, the network device 120 transmits, to the terminal device 110, at least one of the following: a configuration of a signal measurement criterion for an AI model; a configuration for detection of an overheating condition; a configuration for detection of a RLF; a first indication indicating deactivation or reduction of the capabilities of the AI model; a RRC release message; or a RRC reconfiguration message indicating a handover to a target cell, an AI model associated with the target cell being specific to a cell.

In some embodiments, the signal measurement criterion may comprise at least one of the following: a measurement criterion for a stationary terminal device; a measurement criterion for low mobility; a measurement criterion for good serving cell quality; or an s-measure criterion.

In some embodiments, the RRC release message may comprise third information of the AI mode. In some embodiments, the third information may comprise: an indication indicating a logged measurement; an indication indicating deactivation of the capabilities of the AI model; an indication indicating the activation of the capabilities of the AI model; or an indication indicating reduction of capabilities of the AI model.

In some embodiments, the network device 120 may receive, from the terminal device 110, first information indicating that capabilities of an AI model is deactivated or reduced. In some embodiments, the first information may comprise at least one of the following: deactivation of the capabilities of the AI model; a list of the deactivated capabilities of the AI model; a list of the reduced capabilities of the AI model; or a cause indicating the event.

In some embodiments, the network device 120 may receive, from the terminal device 110, second information indicating that the AI model is to be resumed. In some embodiments, based on absence of the first information, the network device 120 may determine that the second information is received.

In some embodiments, the network device 120 may transmit, to the terminal device 110, a second indication indicating whether the terminal device 110 needs to evaluate the AI model based on the signal measurement criterion. In some embodiments, the network device 120 may transmit, to a further network device providing the target cell, information that the AI model is specific to a cell or an area. In some embodiments, the network device 120 may receive, from the further network device, information that an AI model associated with the target cell is specific to a cell or an area. In some embodiments, the network device 120 may transmit, to the terminal device 110, a third indication indicating that the AI model associated with the target cell is specific to a cell or an area.

In some embodiments, the network device 120 may transmit, to the terminal device 110 during a handover, information of a further AI model for replacing the AI model.

With the method 600, a network may configure management of an AI model.

FIG. 7 illustrates another example method 700 of communication implemented at a network device in accordance with some embodiments of the present disclosure. For example, the method 700 may be performed at the network device 120 or 130 as shown in FIG. 1. For the purpose of discussion, in the following, the method 700 will be described with reference to the network device 120 in FIG. 1. It is to be understood that the method 700 may include additional blocks not shown and/or may omit some blocks as shown, and the scope of the present disclosure is not limited in this regard.

At block 710, the network device 120 receives, from the terminal device 110, a measurement report comprising information associated with an AI model.

In some embodiments, the network device 120 may receive the measurement report comprising an indication that the measurement report is triggered by the AI model.

In some embodiments, the network device 120 may transmit AI model information of a set of neighbor cells to the terminal device 110 in system information. In some embodiments, the network device 120 may receive the measurement report comprising an indication indicating that a cell indicated in the measurement report supports the AI model.

In some embodiments, the network device 120 may receive the measurement report comprising an indication of a cell, the cell supporting the AI model.

With the method 700, a network may obtain information of an AI model and optimize mobility management.

### Example Implementation of Device and Apparatus

FIG. 8 is a simplified block diagram of a device 800 that is suitable for implementing embodiments of the present disclosure. The device 800 can be considered as a further example implementation of the terminal device 110 or the network device 120 as shown in FIG. 1. Accordingly, the device 800 can be implemented at or as at least a part of the terminal device 110 or the network device 120.

As shown, the device 800 includes a processor 810, a memory 820 coupled to the processor 810, a suitable transmitter (TX) and receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 830 is assumed to include program instructions that, when executed by the associated processor 810, enable the device 800 to operate in accordance with the embodiments of the present disclosure, as discussed herein with reference to FIGS. 1 to 7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

In some embodiments, a terminal device comprises a circuitry configured to: determine, at a terminal device, that an event occurs; and deactivate or reduce capabilities of an artificial intelligence model, the event comprising at least one of the following: a signal measurement criterion is met; an overheating condition is detected; a radio link failure is detected; a first indication indicating the deactivating or reducing is received; the terminal device enters an idle or inactive state; or a handover to a target cell is to be performed, an artificial intelligence model associated with the target cell being specific to a cell.

In some embodiments, a terminal device comprises a circuitry configured to: transmit, at a terminal device and to a network device, a measurement report comprising information associated with an artificial intelligence model.

In some embodiments, a network device comprises a circuitry configured to: transmitting, at a network device and to a terminal device, at least one of the following: a configuration of a signal measurement criterion for an artificial intelligence model; a configuration for detection of an overheating condition; a configuration for detection of a radio link failure; a first indication indicating deactivation or reduction of the capabilities of the artificial intelligence model; a radio resource control release message; or a radio resource control reconfiguration message indicating a handover to a target cell, an artificial intelligence model associated with the target cell being specific to a cell.

In some embodiments, a network device comprises a circuitry configured to: receive, at a network device and from a terminal device, a measurement report comprising information associated with an artificial intelligence model.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure may provide the following solutions.

In one solution, a method of communication comprises: determining, at a terminal device, that an event occurs; and deactivating or reducing capabilities of an artificial intelligence model, the event comprising at least one of the following: a signal measurement criterion is met; an overheating condition is detected; a radio link failure is detected; a first indication indicating the deactivating or reducing is received; the terminal device enters an idle or inactive state; or a handover to a target cell is to be performed, an artificial intelligence model associated with the target cell being specific to a cell.

In some embodiments, the signal measurement criterion comprises at least one of the following: a measurement criterion for a stationary terminal device; a measurement criterion for low mobility; a measurement criterion for good serving cell quality; or an s-measure criterion.

In some embodiments, the method above further comprises: receiving, from a network device, a second indication indicating whether the terminal device needs to evaluate the artificial intelligence model based on the signal measurement criterion; and in accordance with a determination that the terminal device needs to evaluate the artificial intelligence model, performing signal measurements based on the signal measurement criterion.

In some embodiments, the method above further comprises at least one of the following: transmitting, to a network device, first information indicating that the capabilities of the artificial intelligence model is deactivated or reduced; or starting a prohibit timer upon transmission of the information.

In some embodiments, the first information comprises at least one of the following: deactivation of the capabilities of the artificial intelligence model; a list of the deactivated capabilities of the artificial intelligence model; a list of the reduced capabilities of the artificial intelligence model; or a cause indicating the event.

In some embodiments, the method above further comprises: transmitting, to the network device, second information indicating that the artificial intelligence model is to be resumed. In some embodiments, transmitting the second information comprises: causing absence of the first information.

In some embodiments, the method above further comprises: receiving a radio resource control release message comprising third information of the artificial intelligence model; in accordance with a determination that the third information comprises an indication indicating a logged measurement, continuing to perform actions related to the artificial intelligence model upon entering the idle or inactive state; in accordance with a determination that the third information comprises an indication indicating deactivation of the capabilities of the artificial intelligence model, deactivating the capabilities of the artificial intelligence model based on the third information: in accordance with a determination that the third information comprises an indication indicating the activation of the capabilities of the artificial intelligence model, activating the capabilities of the artificial intelligence model based on the third information; or in accordance with a determination that the third information comprises an indication indicating reduction of capabilities of the artificial intelligence model, reducing the capabilities of the artificial intelligence model based on the third information.

In some embodiments, the method above further comprises: in accordance with a determination that the handover to the target cell is to be performed and the artificial intelligence model is specific to an area, continuing to perform actions related to the artificial intelligence model upon connection with the target cell belonging to the area; or in accordance with a determination that information of a further artificial intelligence model is received during the handover, replacing the artificial intelligence model with the further artificial intelligence model.

In some embodiments, the method above further comprises: receiving a third indication indicating that an artificial intelligence model associated with the target cell is specific to a cell or an area.

In another solution, a method of communication comprises: transmitting, at a terminal device and to a network device, a measurement report comprising information associated with an artificial intelligence model.

In some embodiments, transmitting the measurement report comprises: determining that the measurement report is triggered by the artificial intelligence model; and transmitting the measurement report comprising an indication that the measurement report is triggered by the artificial intelligence model.

In some embodiments, the method above further comprises: receiving, in system information from the network device, artificial intelligence model information of a set of neighbor cells.

In some embodiments, transmitting the measurement report comprises: determining, based on the artificial intelligence model information, that a cell indicated in the measurement report supports the artificial intelligence model; and transmitting the measurement report comprising an indication indicating that the cell supports the artificial intelligence model.

In some embodiments, transmitting the measurement report comprises: determining that a measurement event for radio resource management is triggered; determining, based on the artificial intelligence model information, that a cell associated with the measurement event supports the artificial intelligence model; and transmitting the measurement report comprising an indication of the cell.

In another solution, a method of communication comprises: transmitting, at a network device and to a terminal device, at least one of the following: a configuration of a signal measurement criterion for an artificial intelligence model; a configuration for detection of an overheating condition; a configuration for detection of a radio link failure; a first indication indicating deactivation or reduction of the capabilities of the artificial intelligence model; a radio resource control release message; or a radio resource control reconfiguration message indicating a handover to a target cell, an artificial intelligence model associated with the target cell being specific to a cell.

In some embodiments, the radio resource control release message comprises third information of the artificial intelligence model, the third information comprising: an indication indicating a logged measurement; an indication indicating deactivation of the capabilities of the artificial intelligence model; an indication indicating the activation of the capabilities of the artificial intelligence model; or an indication indicating reduction of capabilities of the artificial intelligence model.

In some embodiments, the signal measurement criterion comprises at least one of the following: a measurement criterion for a stationary terminal device; a measurement criterion for low mobility; a measurement criterion for good serving cell quality; or an s-measure criterion.

In some embodiments, the method above further comprises: receiving, from the terminal device, first information indicating that capabilities of an artificial intelligence model is deactivated or reduced.

In some embodiments, the first information comprises at least one of the following: deactivation of the capabilities of the artificial intelligence model; a list of the deactivated capabilities of the artificial intelligence model; a list of the reduced capabilities of the artificial intelligence model; or a cause indicating the event.

In some embodiments, the method above further comprises: receiving, from the terminal device, second information indicating that the artificial intelligence model is to be resumed. In some embodiments, receiving the second information comprises: determining absence of the first information.

In some embodiments, the method above further comprises at least one of the following: transmitting, to the terminal device, a second indication indicating whether the terminal device needs to evaluate the artificial intelligence model based on the signal measurement criterion; transmitting, to a further network device providing the target cell, information that the artificial intelligence model is specific to a cell or an area; receiving, from the further network device, information that an artificial intelligence model associated with the target cell is specific to a cell or an area; transmitting, to the terminal device, a third indication indicating that the artificial intelligence model associated with the target cell is specific to a cell or an area; or transmitting, to the terminal device during a handover, information of a further artificial intelligence model for replacing the artificial intelligence model.

In another solution, a method of communication comprises: receiving, at a network device and from a terminal device, a measurement report comprising information associated with an artificial intelligence model.

In some embodiments, receiving the measurement report comprises: receiving the measurement report comprising an indication that the measurement report is triggered by the artificial intelligence model.

In some embodiments, the method above further comprises: transmitting, to the terminal device and in system information, artificial intelligence model information of a set of neighbor cells.

In some embodiments, receiving the measurement report comprises: receiving the measurement report comprising an indication indicating that a cell indicated in the measurement report supports the artificial intelligence model.

In some embodiments, receiving the measurement report comprises: receiving the measurement report comprising an indication of a cell, the cell supporting the artificial intelligence model.

In another solution, a device of communication comprises: a processor configured to cause the device to perform any of the methods above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication, comprising:
determining, at a terminal device, that an event occurs; and
deactivating or reducing capabilities of an artificial intelligence model, the event comprising at least one of the following:
a signal measurement criterion is met;
an overheating condition is detected;
a radio link failure is detected;
a first indication indicating the deactivating or reducing is received;
the terminal device enters an idle or inactive state; or
a handover to a target cell is to be performed, an artificial intelligence model associated with the target cell being specific to a cell.

2. The method of claim 1, wherein the signal measurement criterion comprises at is least one of the following:
a measurement criterion for a stationary terminal device;
a measurement criterion for low mobility;
a measurement criterion for good serving cell quality; or
an s-measure criterion.

3. The method of claim 1, further comprising:
receiving, from a network device, a second indication indicating whether the terminal device needs to evaluate the artificial intelligence model based on the signal measurement criterion; and
in accordance with a determination that the terminal device needs to evaluate the artificial intelligence model, performing signal measurements based on the signal measurement criterion.

4. The method of claim 1, further comprising at least one of the following:
transmitting, to a network device, first information indicating that the capabilities of the artificial intelligence model is deactivated or reduced; or
starting a prohibit timer upon transmission of the information.

5. The method of claim 4, wherein the first information comprises at least one of the following:
deactivation of the capabilities of the artificial intelligence model;
a list of the deactivated capabilities of the artificial intelligence model;
a list of the reduced capabilities of the artificial intelligence model; or
a cause indicating the event.

6. The method of claim 4, further comprising:
transmitting, to the network device, second information indicating that the artificial intelligence model is to be resumed.

7. The method of claim 6, wherein transmitting the second information comprises:
causing absence of the first information.

8. The method of claim 1, further comprising:
receiving a radio resource control release message comprising third information of the artificial intelligence model;
in accordance with a determination that the third information comprises an indication indicating a logged measurement, continuing to perform actions related to the artificial intelligence model upon entering the idle or inactive state;
in accordance with a determination that the third information comprises an indication indicating deactivation of the capabilities of the artificial intelligence model, deactivating the capabilities of the artificial intelligence model based on the third information;
in accordance with a determination that the third information comprises an indication indicating the activation of the capabilities of the artificial intelligence model, activating the capabilities of the artificial intelligence model based on the third information; or
in accordance with a determination that the third information comprises an indication indicating reduction of capabilities of the artificial intelligence model, reducing the capabilities of the artificial intelligence model based on the third information.

9. The method of claim 1, further comprising:
in accordance with a determination that the handover to the target cell is to be performed and the artificial intelligence model is specific to an area, continuing to perform actions related to the artificial intelligence model upon connection with the target cell belonging to the area; or
in accordance with a determination that information of a further artificial intelligence model is received during the handover, replacing the artificial intelligence model with the further artificial intelligence model.

10. The method of claim 1, further comprising:
receiving a third indication indicating that an artificial intelligence model associated with the target cell is specific to a cell or an area.

11. A method of communication, comprising:
transmitting, at a terminal device and to a network device, a measurement report comprising information associated with an artificial intelligence model.

12. The method of claim 11, where transmitting the measurement report comprises:
determining that the measurement report is triggered by the artificial intelligence model; and
transmitting the measurement report comprising an indication that the measurement report is triggered by the artificial intelligence model.

13. The method of claim 11, further comprising:
receiving, in system information from the network device, artificial intelligence model information of a set of neighbor cells.

14. The method of claim 13, where transmitting the measurement report comprises:
determining, based on the artificial intelligence model information, that a cell indicated in the measurement report supports the artificial intelligence model; and
transmitting the measurement report comprising an indication indicating that the cell supports the artificial intelligence model.

15. The method of claim 13, where transmitting the measurement report comprises:
determining that a measurement event for radio resource management is triggered;
determining, based on the artificial intelligence model information, that a cell associated with the measurement event supports the artificial intelligence model; and
transmitting the measurement report comprising an indication of the cell.

16. A device of communication comprising:
a processor configured to perform the method according to any of claims 1-10 or any of claims 11-15.
